(19) United States
(12) Patent Application Publication
(10) Pub. No.: US 2012/0159330 A1
(43) Pub. Date: Jun. 21, 2012

(54) METHOD AND APPARATUS FOR PROVIDING RESPONSE OF USER INTERFACE

(75) Inventors: Ki-jun JEONG, Seoul (KR); Hee-seob RYU, Hwaseong-si (KR); Yeun-bae KIM, Seongnam-si (KR); Seung-kwon PARK, Yongin-si (KR); Jung-min KANG, Seoul (KR)

(73) Assignee: SAMSUNG ELECTRONICS CO., LTD., Suwon-si (KR)

(21) Appl. No.: 13/329,505

(22) Filed: Dec. 19, 2011

(30) Foreign Application Priority Data
Dec. 17, 2010 (KR) 2010-0129793

(51) Int. Cl. G06F 3/048

(52) U.S. Cl. 715/716; 715/863

(57) ABSTRACT

A method and an apparatus for providing a user interface in response to a user's motion. The response providing apparatus captures the user in an image frame and stores data corresponding to a predefined user gesture. The response providing apparatus provides the user interface in response to the user's motion using the data with respect to the identified user.

### CROSS-REFERENCE TO RELATED APPLICATIONS

This application claims priority from Korean Patent Application No. 10-2010-0129793, filed on Dec. 17, 2010, in the Korean Intellectual Property Office, the disclosure of which is incorporated herein by reference in its entirety.

### BACKGROUND

1. Field

The present general inventive concept is consistent with a technique for providing a user interface as a response. More particularly, the present general inventive concept is consistent with a technique for providing user interface as a response to a motion of a user.

2. Description of the Related Art

A user interface can provide temporary or continuous access to allow communication between a user and an object, a system, a device, or a program. The user interface can include a physical medium and/or a virtual medium. In general, the user interface can be divided into input which is user's system manipulation, and output which is a response or a result from the input of the system.

The input requires an input device for the user's manipulation to move a cursor in a screen or to select a particular object. The output requires an output device for obtaining the response to the input with the user's sight, hearing, and/or touch sense.

Recently, for improved user convenience, devices such as a television and a game console are under development to remotely recognize a user's motion as the input and provide in response the user interface that corresponds to the user's motion.

### SUMMARY

Exemplary embodiments may overcome the above disadvantages and other disadvantages not described above. The present general inventive concept is not required to overcome the disadvantages described above, and an exemplary embodiment may not overcome any of the problems described above.

A method and an apparatus are provided for adaptively providing a user interface in response to a user's motion by retaining and using a gesture profile of the user including information of the motion in a three dimensional space in a memory.

A method and an apparatus are provided for providing a more reliable response of a user interface by obtaining an image frame which captures a user's motion imitating a preset gesture, and updating a gesture profile with data calculated from the user's motion in the image frame.

A method and an apparatus are provided for retaining data in a gesture profile of a user more easily by updating the gesture profile of the user using a user's motion to acquire a response of a user interface.

According to one aspect, a method of providing a user interface in response to a user motion includes capturing the user motion in an image frame; identifying a user of the user motion; accessing a gesture profile of the user, the gesture profile including at least one data corresponding to at least one gesture and the at least one data that identifies the user motion corresponding to a respective gesture; comparing the user motion in the image frame with the at least one data in the gesture profile of the user to determine the respective gesture; and providing the user interface in response to the user motion based on the comparison.

The method may further include updating the gesture profile of the user using the user motion.

The method may further include storing in an area of a memory allocated to the user the user identification information together with the gesture profile of the user, and where the identifying the user may include determining whether a shape of the user matches the identification information of the user.

The method may further include if the user is not identified, providing the user interface in response to the user motion using the user motion in the image frame and a basic gesture profile for an unspecified user.

The one or more data in the gesture profile indicates information relation to the user motion in a three dimensional space.

The information relating to the motion in the three dimensional space may include information relating to an amount of motion in an x axis direction in the image frame, an amount of motion in a y axis direction in the image frame, and an amount of motion in a z axis direction perpendicular to the image frame.

The information relating to the motion in the three dimensional space may include at least two three-dimensional coordinates including an x axis component, a y axis component, and a z axis component.

The gesture profile of the user may be updated with the data calculated from a first user motion in the first image frame. The first image frame may be obtained by capturing the first user motion which imitates a predefined gesture.

The at least one gesture may include at least one of flick, push, hold, circling, gathering, and widening.

The user interface provided in response may include at least one of a display power-on, a display power-off, a display of a menu, a movement of a cursor, a change of an activated item, a selection of an item, an operation corresponding to the item, a change of a display channel, and a volume change.

According to yet another aspect, an apparatus for providing a user interface in response to a user motion includes a sensor which captures a user motion in an image; a memory which stores a gesture profile of a user of the user motion, the gesture profile including at least one data identifying at least one gesture and the at least one data that identifies the user motion; and a controller which identifies the user, which accesses the gesture profile of the user, which compares the user motion in the image frame and the at least one data in the gesture profile of the user to determine the respective gesture, and which provides the user interface in response to the user motion based on the comparison.

The controller may update the gesture profile of the user using the user motion.

An area in a memory allocated to the user may store user identification information together with the gesture profile of the user, and the controller may identify the user by determining whether a shape of the user matches the user identification information.

If the user is not identified, the controller may provide the user interface in response to the user motion based on the user motion in the image frame and a basic gesture profile for an unspecified user.

The at least one data in the gesture profile indicates information relating to the user motion in a three dimensional space.

The information relating to the user motion in the three dimensional space may include information relating to an amount of motion in an x axis direction in the image frame, an amount of motion in a y axis direction in the image frame, and an amount of motion in a z axis direction perpendicular to the image frame.

The information relating to the user motion in the three dimensional space may include at least two three-dimensional coordinates comprising an x axis component, a y axis component, and a z axis component.

The gesture profile of the user may be updated with the data calculated from a first user motion in a first image frame, and the first image frame may be obtained by capturing the first user motion which imitates a predefined gesture.

The at least one gesture may include at least one of flick, push, hold, circling, gathering, and widening.

The user interface provided in response may include at least one of display power-on, display power-off, display of a menu, a movement of a cursor, a change of an activated item, a selection of an item, an operation corresponding to the item, a change of a display channel, and a volume change.

According to another aspect, a method of providing a user interface in response to a user motion includes capturing a first user motion which imitates a predefined gesture in a first image frame; calculating data indicating a three dimensional motion information which corresponds to the predefined gesture, from the first user motion in the first image frame; updating a user gesture profile with the calculated data and storing the updated gesture profile in an area of a memory allocated to a user that performs the user motion, where the user gesture profile may include at least one data corresponding to at least one gesture; identifying the user of the user motion; accessing the user gesture profile; and comparing a second user motion in a second image frame and the at least one data in the user gesture profile and providing the user interface in response to the user second motion.

The capturing the first user motion may include providing guidance to the user to perform the predefined gesture; and obtaining identification information of the user.

The method may include updating the user gesture profile using the second user motion.

The area in the memory allocated to the user may further store user identification information together with the user gesture profile, and the identifying of the user may include determining whether a shape of the user matches the user identification information.

The method may further include if the user is not identified, providing the user interface in response to the user motion using the user motion in the image frame and a basic gesture profile for an unspecified user.

The user interface provided in the response may include determining which one of the at least one gesture the user motion relates to by comparing the user motion in the image frame and the at least one data in the user gesture profile; and providing the user interface corresponding to the gesture in response according to the determination result.

The information relating to the user motion in the three dimensional space may include information relating to an amount of motion in an x axis direction in the image frame, an amount of motion in a y axis direction in the image frame, and an amount of motion in a z axis direction perpendicular to the image frame.

The information relating to the user motion in the three dimensional space may include at least two three-dimensional coordinates comprising an x axis component, a y axis component, and a z axis component.

The at least one gesture may include at least one of flick, push, hold, circling, gathering, and widening.

The user interface provided in response may include at least one of a display power-on, a display power-off, a display of a menu, a movement of a cursor, a change of an activated item, a selection of an item, an operation corresponding to the item, a change of a display channel, and a volume change.

According to an yet another aspect, an apparatus for providing a user interface in response to a user motion includes a sensor which captures a first user motion in a first image frame which imitates a predefined gesture; a controller which calculates data indicating a three dimensional motion information which corresponds to the predefined gesture, from the first user motion in the first image frame; and a memory which updates a user gesture profile with the data and stores the updated gesture profile in an area of the memory allocated to the user, where the gesture profile includes at least one data corresponding to at least one gesture. The controller identifies the user, accesses the user gesture profile, and compares a second user motion in a second image frame and the at least one data in the user gesture profile, and provides the user interface in response to the second user motion.

The controller may control to provide guidance for the predefined gesture, and obtain user identification information.

The controller may update the user gesture profile using the second user motion.

The area of the memory allocated to the user may further store user identification information together with the user gesture profile, and the controller may identify the user by determining whether a shape of the user matches the user identification information.

If the user is not identified, the controller may provide the user interface in response to the user motion using the user motion in the image frame and a basic gesture profile for an unspecified user.

The controller may determine which one of the at least one gesture the user motion relates to by comparing the user motion in the image frame and the at least one data in the user gesture profile, and provide the user interface corresponding to the gesture in response according to the determination result.

The information relating to the motion in the three dimensional space may include information relating to an amount of motion in an x axis direction in the image frame, an amount of motion in a y axis direction in the image frame, and an amount of motion in a z axis direction perpendicular to the image frame.

The information relating to the motion in the three dimensional space may include at least two three-dimensional coordinates comprising an x axis component, a y axis component, and a z axis component.

The at least one gesture may include at least one of flick, push, hold, circling, gathering, and widening.

The user interface provided in response may include at least one of a display power-on, a display power-off, a display of a menu, a movement of a cursor, a change of an activated item, a selection of an item, an operation corresponding to the item, a change of a display channel, and a volume change.

According to yet another aspect, a method of providing a user interface in response to a user motion includes capturing the user motion in an image frame; identifying a user performing the user motion; accessing training data indicating motion information of the user in a three dimensional space corresponding to a predefined gesture; comparing the user motion and the training data; and providing the user interface in response to the user motion based on the comparison.

According to another aspect, an apparatus for providing a user interface in response to a user motion includes a sensor which capturing the user motion in an image frame; a memory which stores training data indicating user motion information in a three dimensional space corresponding to a predefined gesture; and a controller which identifies a user performing the user motion, which accesses the training data, which compares the user motion with the training data, and which provides the user interface in response to the user motion based on the comparison.

According to another aspect, a method of providing a user interface in response to a user motion includes capturing a first use motion in a first image frame which imitates a predefined gesture; calculating training data indicating motion information in a three dimensional space corresponding to the predefined gesture from the first user motion in the first user image frame and storing the training data; identifying a user that performs the first user motion; accessing the training data; and comparing a second user motion in a second image frame and the training data and providing the user interface in response to the second user motion.

According to another aspect, an apparatus for providing a user interface in response to a user motion includes a sensor which captures a first user motion imitating a predefined gesture in a first image frame; a controller which calculates training data indicating motion information in a three dimensional space corresponding to the predefined gesture from the first user motion; and a memory which stores the training data corresponding to the predefined gesture in an area allocated to a user which performs the first user motion. The controller identifies the user, accesses the training data stored in the area in the memory allocated to the user, compares a second user motion in a second image frame and the training data stored in the area in the memory allocated to the user, and provides the user interface in response to the second user motion.

### BRIEF DESCRIPTION OF THE DRAWINGS

The above and/or other aspects will become more apparent by describing certain exemplary embodiments with reference to the accompanying drawings, in which:

FIG. 1 is a block diagram illustrating an apparatus for providing a response of a user interface according to an exemplary embodiment;

FIG. 2 is a block diagram illustrating a user interface provided in response to a user's motion according to an exemplary embodiment;

FIG. 3 is a block diagram illustrating a sensor according to an exemplary embodiment;

FIG. 4 is a diagram illustrating image frames with a user according to an exemplary embodiment;

FIG. 5 is a diagram illustrating the sensor and a shooting location according to an exemplary embodiment;

FIG. 6 is a diagram illustrating the user's motion in the image frame according to an exemplary embodiment;

FIG. 7 is a flowchart illustrating a method for providing the response which is the user interface according to an exemplary embodiment;

FIG. 8 is a flowchart illustrating a method for providing the response which is the user interface according to an exemplary embodiment;

FIG. 9 is a flowchart illustrating a method for providing the response which is the user interface according to yet another exemplary embodiment; and

FIG. 10 is a flowchart illustrating a method for providing the response which is the user interface according to yet another exemplary embodiment.

### DETAILED DESCRIPTION OF EXEMPLARY EMBODIMENTS

Exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of the invention. However, the present general inventive concept can be practiced without those specifically defined matters. Also, well-known functions or constructions are not described in detail since they would obscure the invention with unnecessary detail.

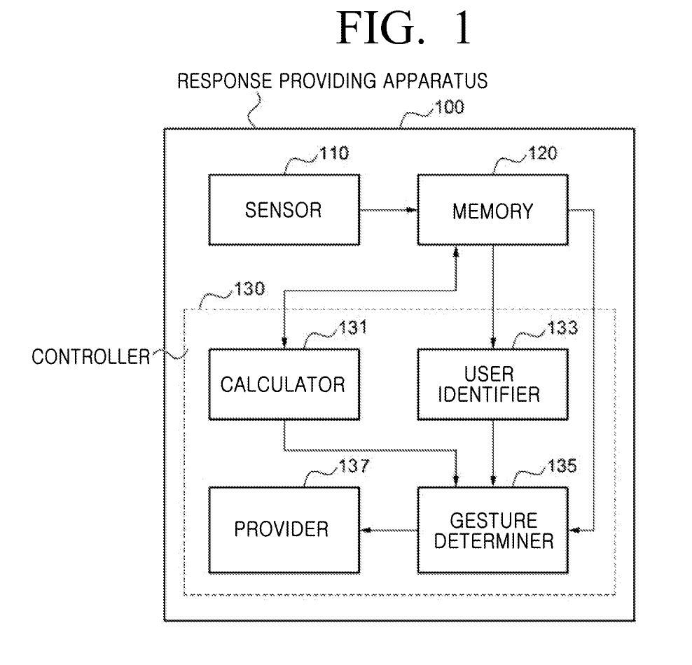

FIG. 1 is a block diagram illustrating an apparatus for providing a response of a user interface according to an exemplary embodiment.

The response providing apparatus 100 can include a sensor 110, a memory 120, and/or a controller 130. The controller 130 can include a calculator 131, a user identifier 133, a gesture determiner 135, and/or a provider 137. That is, the controller 130 can include at least one processor configured to function as the calculator 131, the user identifier 133, the gesture determiner 135, and/or the provider 137.

The response providing apparatus 100 of the user interface can obtain a user's motion using an image frame, determine which gesture the user's motion relates to, and provide in response the user interface corresponding to the gesture according to the result of the determination. That is, the user interface is provided which can signify that a command or an event corresponding to the user's motion is performed or a device including the user interface operates according to the determined gesture.

The sensor 110 can detect a location of the user. The sensor 110 can obtain the image frame including the information of the user's location by capturing the user and/or the user's motion. Herein, the user or the user in the image frame, which is the detection subject of the sensor 110, can be the entire body of the user, part of the body (for example, a face or at least one hand), or a tool used by the user (for example, a bar grabbable with the hand). The information of the location can include at least one of coordinates for the vertical direction in the image frame, coordinates for the horizontal direction in the image frame, and user's depth information indicating distance between the user and the sensor 110. Herein, the depth information can be represented as a coordinate value of the direction perpendicular to the image frame. For example, the sensor 110 can obtain an image frame including the depth information (indicating the distance between the user and the sensor 110) by capturing the user. As the information of the user's location, the sensor 110 can acquire the coordinates for the vertical direction in the image frame, the coordinates for the horizontal direction in the image frame, and the depth information. The sensor 110 can employ a depth sensor, a two dimensional camera, or a three dimensional camera including a stereoscopic camera. Also, the sensor 110 may employ a device for locating an object by sending and receiving ultrasonic waves or radio waves.

The sensor 110 can provide user identification data, which is required for the controller 130 to identify the user. For example, the sensor 110 can provide the controller 130 with the image frame obtained by capturing the user. The sensor 110 can employ any one of the depth sensor, the two dimensional camera, and the three dimensional camera. The sensor 110 can include at least two of the depth sensor, the two dimensional camera, and the three dimensional camera. When the user identification data is voice data scanning, fingerprint scanning, or retinal scanning, the sensor 110 can include a microphone, a fingerprint scanner, or the retinal scanner.

The sensor 110 can obtain a first image frame by capturing a first motion of the user imitating a predefined gesture. In so doing, the controller 130 can control the response providing apparatus 100 to provide a guide for the predefined gesture, and acquire the user identification information using the identification information received from the sensor 110. The controller 130 can control to retain the acquired user identification information in the memory 120.

The memory 120 can store the image frame acquired by the sensor 110, the user's location, or the user identification information. The memory 120 can store a preset number of image frames continuously or periodically acquired from the sensor 110 in a certain time period, or image frames in a preset time period. The memory 120 can retain the user's gesture profile in a user area. The gesture profile includes at least one data (or training data) corresponding to at least one gesture, and the at least one data can indicate motion information in the three dimensional space. Herein, the motion information in the three dimensional space can include a size of an x axis direction motion in the image frame, a size of a y axis direction motion in the image frame, and a size of a z axis direction motion perpendicular to the image frame. In the exemplary implementations, the information of the motion in the three dimensional space may include at least two three-dimensional coordinates including an x axis component, a y axis component, and a z axis component.

At least one gesture can include at least one of flick, push, hold, circling, gathering, and widening. The response of the user interface can be a preset event corresponding to a particular gesture. For example, the response of the user interface can include at least one of display power-on, display power-off, display of a menu, movement of a cursor, change of an activated item, selection of the item, operation corresponding to the item, change of a display channel, and volume change.

The data is compared with the user's motion and can be used to determine which gesture the user's motion relates to. The data can be used to determine whether a particular gesture takes place, or to determine the preset event as the response of the user interface.

Alternatively, the memory 120 can retain the training data indicating the user's motion information in the three dimensional space corresponding to the predefined gesture, in the user area. The memory 120 can further retain the user identification information together with the training data corresponding to the predefined gesture, in the user area. The controller 130 can identify the user by determining whether a user's shape matches the identification information of the user retained in the memory 120.

As such, the response providing apparatus 100 of the user interface can retain and use in the memory 120, the gesture profile or the training data of the user including the motion information in the three dimensional space, and thus adaptively provide the response of the user interface for the user's motion.

The controller 130 can identify the user and access the user's gesture profile retained in the user area of the memory 120. The controller 130 can provide the response of the user interface with respect to the user's motion by comparing the user's motion in the image frame and data in the user's gesture profile. That is, the controller 130 can determine which one of one or more gestures the user's motion relates to by comparing the user's motion in the image frame and the data in the user's gesture profile, and provide the user interface in response, where the user interface corresponds to the gesture according to the determination result. Herein, the user's gesture profile can be updated with data calculated from the first motion of the user in a first image frame. The first image frame can be acquired by capturing the first motion of the user imitating the predefined gesture.

The controller 130 can update the user's gesture profile with the user's motion. The controller 130 can identify the user by determining whether the user's shape matches the user's identification information. When the user cannot be identified, the controller 130 can provide the user interface in response to the user's motion using the user's motion in the image frame and a basic gesture profile for unspecified users.

Alternatively, the controller 130 can identify the user using the image frame and access the training data of this user retained in the user area of the memory 120. The controller 130 can provide the user interface in response to the user's motion by comparing the user's motion in the image frame and the training data retained in the user area. That is, the controller 130 can determine whether the user's motion is the predefined gesture by comparing the user's motion in the image frame and the training data retained in the user area, and provide in response, the user interface corresponding to the predefined gesture.

The controller 130 can include the calculator 131, the user identifier 133, the gesture determiner 135, and/or the provider 137.

The calculator 131 can detect the user's motion in the image frame using at least one image frame stored in the memory 120 or using the information of the user's location. The calculator 131 can calculate the information of the user's motion in the three dimensional space using at least one image frame. For example, the calculator 131 can calculate the dimensional displacement of the user's motion based on two or more three-dimensional coordinates of the user in at least two image frames. At this time, the dimensional displacement of the user's motion can include the positional displacement of the x axis direction motion in the image frame, the positional displacement of the y axis direction motion in the image frame, and the positional displacement of the z axis direction motion perpendicular to the image frame. For example, the calculator 131 can calculate a straight length from the start coordinates to the end coordinates of the users' motion as the positional displacement or distance of the motion. The calculator 131 may draw a virtual straight line near the coordinates of the user in the image frame using a heuristic scheme, and calculate the virtual straight length as the distance of the motion. The calculator 131 can further calculate information about a direction of the user's motion. The calculator 131 can further calculate information about a speed of the user's motion.

The calculator 131 can update the training data or the gesture profile indicating the user' motion information. For example, the calculator 131 can update the training data or the gesture profile in a leading mode and/or in a following mode.

In the leading mode, the controller 130 can control the response providing apparatus 100 to provide guidance for the predefined gesture to the user. At this time, the sensor 110 can obtain the first image frame by capturing the first motion of the user imitating the predefined gesture. The controller 130 can acquire the identification information of the user. For example, as the identification information of the user, the controller 130 can obtain a height, a facial contour, a hairstyle, clothes, or a body size using the image frame. The calculator 131 of the controller 130 can calculate the data (or the training data) indicating the motion information in the three dimensional space corresponding to the predefined gesture from the first motion of the user in the first image frame. At this time, the memory 120 can update the user's gesture profile with the calculated data and retain the updated gesture profile in the user area. Alternatively, the memory 120 can retain the calculated training data corresponding to the predefined gesture in the user area. As such, the response providing apparatus 100 of the user interface can obtain the image frame by capturing the user's motion imitating the predefined gesture, update the gesture profile with the training data based on the user's motion in the image frame, and thus provide a more reliable response of the user interface.

In the following mode, using the user's motion to yield the response of the user interface, the controller 130 can update the user's gesture profile or the user's training data and thus more easily retain the data of the user's gesture profile or the training data corresponding to the predefined gesture. For example, the calculator 131 can update the user's gesture profile using the user's motion. That is, the calculator 131 can acquire the updated gesture profile of the user by modifying the first data corresponding to the first gesture in the user's gesture profile to second data based on a preset equation with the user's motion. Alternatively, the calculator 131 can update the training data corresponding to the predefined gesture using the user's motion. For example, the calculator 131 can update the existing training data to new data based on a preset equation with the user's motion.

The user identifier 133 can obtain the user's identification information from the identification data of the user received from the sensor 110 or the memory 120. The user identifier 133 can control to retain the obtained identification information of the user in the user area of the corresponding user of the memory 120. The user identifier 133 can identify the user by determining whether the user's identification information obtained from the user's identification data matches the user's identification information retained in the memory 120. For example, the user's identification data can use the data relating to the image frame, the voice scanning, the fingerprint scanning, or the retinal scanning. When the image frame is used, the user identifier 133 can identify the user by determining whether the user's shape matches the user's identification information.

The user identifier 133 can provide the gesture determiner 135 with location information or address of the user area of the memory 120 corresponding to the identified user.

The gesture determiner 135 can access the gesture profile or the training data of the identified user in the memory 120 using the location information or the address of the user area provided from the user identifier 133. Also, the gesture determiner 135 can determine which one of one or more gestures in the gesture profile of the identified user is related to the user's motion of the image frame received from the calculator 131. Alternatively, the gesture determiner 135 can compare the user's motion of the image frame and the training data retained in the user area and thus determine whether the user's motion is the predefined gesture.

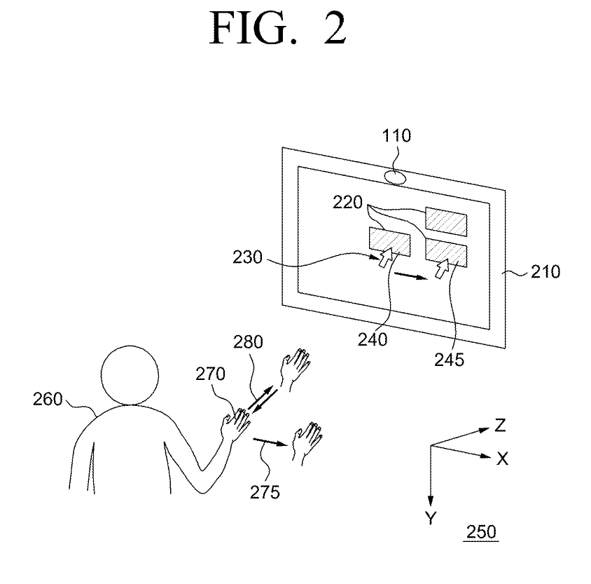

The provider 137 can provide the response of the user interface corresponding to the gesture according to the determination result of the gesture determiner 135. That is, the provider 137 can generate an interrupt signal to generate an event corresponding to the determined gesture. For example, the provider 137 can control the response providing apparatus to instruct the display of the response to the user's motion on a screen which displays a menu such as an exemplary menu 220 illustrated in FIG. 2.

Now, the operations of the components according to an exemplary embodiment are explained in more detail by referring to FIGS. 2 through 6.

FIG. 2 is a block diagram illustrating the user interface in response to the user's motion according to an exemplary embodiment.

A device 210 illustrated in FIG. 2 includes the response providing apparatus 100 of the user interface, or can operate in association with the response providing apparatus 100 of the user interface. The device 210 can be a media system or an electronic device. The media system can include a television, a game console, and/or a stereo system. The user that provides the motion can be the entire body of the user 260, part of the body of the user 260, or the tool used by the user 260.

The memory 120 (shown in FIG. 1) of the response providing apparatus 100 (also shown in FIG. 1) of the user interface can retain the user's gesture profile in the user area. The memory 120 can retain the training data indicating the user's motion information in the three dimensional space corresponding to the predefined gesture, in the user area. At least one gesture can include at least one of the flick, the push, the hold, the circling, the gathering, and the widening. The user interface provided in response can be a preset event corresponding to a particular gesture. For example, the user interface provided in response can include at least one of the display power-on, the display power-off, the menu display, the cursor movement, the change of the activated item, the item selection, the operation corresponding to the item, the change of the display channel, and the volume change. The particular gesture can be mapped to a particular event, and some gestures can generate other events according to graphical user interfaces.

For example, when the user's motion indicates the circling gesture, the response providing apparatus 100 (shown in FIG. 1) can provide the user interface response for the display power-on or power-off of the device 210.

As the event provided in response to the user 260 (or the motion (e.g., the flick) of a hand 270) in a direction 275 of FIG. 2, the activated item of the displayed menu 220 of the device 210 can be changed from an item 240 to an item 245. The controller 130 can control the response providing apparatus 100 to instruct the device 210 to display the movement of the cursor 230 according to the motion of the user 260 (or the hand 270) and to display whether the item is activated by determining whether the cursor 230 is placed in the regions of the item 240 and the item 245.

Regardless of the display of the cursor 230, the controller 130 can control the response providing apparatus 100 to instruct the device 210 to discontinuously display the change of the activated item. In so doing, the controller 130 can compare the size of the motion of the first user in the image frame acquired by the sensor 110 and the training data retained in the user area of the first user corresponding to and the predefined gesture or at least one data in the gesture profile of the first user. The predefined gesture can be a necessary condition to change the activated item. The controller 130 can determine whether to change the activated item to an adjacent item through the comparison. For example, it can be assumed that the data in the gesture profile of the first user, which is compared when the activated item is changed by shifting by one space is 5 cm (about 2 inches) movement size in the x or y axis direction. When the displacement amount of the motion of the first user in the image frame received from the sensor 110 or the memory 12 is 3 cm (about an inch) in the x or y axis direction, the controller 130 can control not to change the activated item by comparing the motion of the first user and the data. At this time, the response of the user interface to the motion of the first user can indicate no movement of the activated item, no interrupt signal, or maintaining the current state. When the size of the motion of the first user is 12 cm (about 5 inches) in the x or y axis direction, the controller 130 can activate the item adjacent by two spaces as the event. The controller 130 can generate the interrupt signal for the two-space shift of the activated item as the response of the user interface for the motion of the first user.

Also, it can be assumed that the data in the gesture profile of the second user, which is compared when the activated item is changed by shifting by one space is 9 cm (about 3.5 inches) movement size in the x or y axis direction. When the motion size of the second user in the image frame is 12 cm (about 5 inches) in the x or y axis direction, the controller 130 can determine to activate the item adjacent by one space as the event.

As the event corresponding to the response to the motion (e.g., the push) of the user 260 (or the hand 270) in a direction 280, the activated item 240 in the displayed menu 220 of the device 210 can be selected. In so doing, the data in the gesture profile of the user or the training data corresponding to the gesture (e.g., the push) for the item selection can include information of the z axis direction size to compare the z axis direction size of the user's motion.

As such, the motion for the same gesture differs per user. Hence, the response providing apparatus 100 of the user interface can maintain the motion information of the x, y, and y axes for the user's gesture as the gesture profile or the training data together with the identification information of the corresponding user, and utilize the gesture profile or the training data to provide an appropriate response of the user interface for the corresponding user.

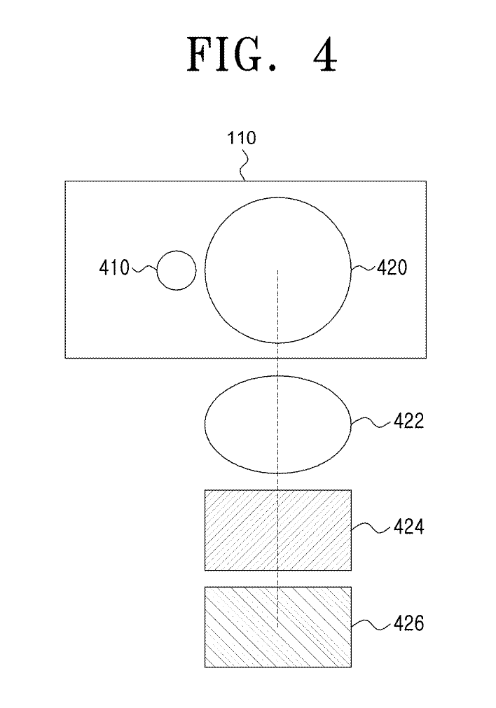

FIG. 4 depicts image frames with a user therein according to an exemplary embodiment.

The sensor 110 can obtain an image frame 410 of FIG. 4 including the hand 270 of the user 260. The image frame 410 can include outlines of objects having lengths in a certain range and depth information corresponding to the outline, similarly to a contour line. The outline 412 corresponds to the hand 270 of the user 260 in the image frame 410 and can have the depth information indicating the distance between the hand 270 and the sensor 110. The outline 414 corresponds to part of the arm of the user 260, and the outline 416 corresponds to the head and the upper part body of the user 260. The outline 418 can correspond to the background behind the user 260. The outline 412 through the outline 418 can have different depth information.

The controller 130 can detect the user and the user's location using the image frame 410. For example, the user in the image frame 410 can be the hand of the user. The controller 130 can detect the user 412 in the image frame 410 and control to include only the detected user 422 in the image frame 420. The controller 130 can control the response providing apparatus to instruct display of the user 412 in a different shape in the image frame 410. For example, the controller 130 can control the response providing apparatus to instruct to represent the user 432 of the image frame 430 using at least one point, line, or plane.

The controller 130 can represent the user 432 of the image frame 430 as a point and the location of the user 432 using three dimensional coordinates. The three dimensional coordinates include x, y, and/or z axis components, the x axis can correspond to the horizontal direction in the image frame, and the y axis can correspond to the vertical direction in the image frame. The z axis can correspond to the direction perpendicular to the image frame; that is, the value of the depth information.

The controller 130 can calculate information relating to the user's motion in the three dimensional space through at least one image frame. For example, the controller 130 can track the location of the user in the image frame and calculate the amount of the user's motion based on the three dimensional coordinates of the user in two or more image frames. The size of the user's motion can be divided to x, y, and/or z axis components.

The memory 120 can store the image frame 410 acquired by the sensor 110. The memory 120 can store at least two image frames consecutively or periodically. The memory 120 can store the image frame 422 or the image frame 430 processed by the controller 130. Herein, the three dimensional coordinates of the user 432 can be stored in place of the image frame 430 including the depth information of the user 432.

When the image frame 435 includes a plurality of virtual regions divided into the grid, the coordinates of the user 432 can be represented by the region including the user 432 or the coordinates of the corresponding region. In the implementations, the grid regions each can be a minimum unit of the sensor 110 for obtaining the image frame and forming the outline, or divided by the controller 130. Similar to the image frame divided into the grid, the depth information may be divided in a preset unit size. By dividing the image frame into the regions or the depth of the unit size, the data about the user's location and the user's motion size can be reduced.

When the user 432 belongs to part of the plurality of the regions in the image frame 435, the corresponding image frame 435 may not be used to calculate the location of the user 432 or the motion of the user 432. That is, when the user 432 belongs to part of the regions and the motion of the user 432 in the image frame 435 is calculated differently from the user's motion actually captured over a certain degree, the location of the user 432 in the corresponding partial regions may not be used. Herein, the partial regions can include the regions corresponding to the edge of the image frame 435. For example, when the user belongs to the regions corresponding to the edge of the image frame, it is possible to preset the apparatus so as not to use the corresponding image frame to calculate the user's location or the user's motion.

The sensor 110 can obtain the coordinates in the vertical direction in the image frame and the coordinates in the horizontal direction in the image frame, as the user's location. Also, the sensor 110 can obtain the user's depth information indicating the distance between the user and the sensor 110, as the user's location. The sensor 110 can employ the depth sensor, the two dimensional camera, or the three dimensional camera including the stereoscopic camera. The sensor 110 may employ a device for locating the user by sending and receiving ultrasonic waves or radio waves.

For example, when a general optical camera is used as the two dimensional camera, the controller 130 can detect the user by processing the obtained image frame. The controller 130 can locate the user in the image frame and detect the user's size in the image frame or the user's size. The controller 130 can obtain the depth information using a mapping table of the depth information based on the detected size. When the stereoscopic camera is used as the camera 110, the controller 130 can acquire the user's depth information using parallax or focal length.

The sensor 110 may further include a separate sensor for identifying the user, in addition to the sensor for obtaining the image frame.

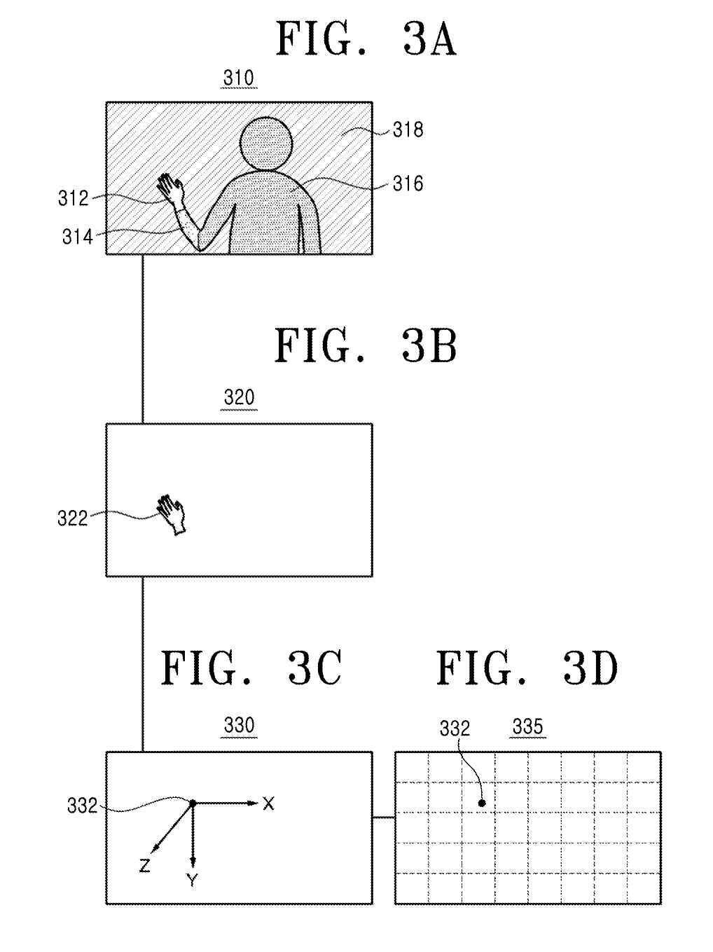

The depth sensor used as the sensor 110 is explained by referring to FIG. 3.

FIG. 3 is a block diagram illustrating a sensor according to an exemplary embodiment.

The sensor 110 of the FIG. 3 can be a depth sensor. The sensor 110 can include an infrared transmitter 310 and an optical receiver 320. The optical receiver 320 can include a lens 322, an infrared filter 324, and an image sensor 326. The infrared transmitter 310 and the optical receiver 320 can be disposed at the same or adjacent distance. The sensor 110 can have the field of view as a unique value according to the optical receiver 320. The infrared light transmitted through the infrared transmitter 310 arrives at and is reflected by objects including the user in the front, and the reflected infrared light can be received at the optical receiver 320. The lens 322 can receive optical components of the objects, and the infrared filter 324 can pass the infrared light of the received optical components. The image sensor 326 can convert the passed infrared light to an electric signal and thus obtain the image frame. For example, the image sensor 326 can employ a Charge Coupled Device (CCD) or a Complementary Metal Oxide Semiconductor (CMOS). The image frame obtained by the image sensor 326 can be the image frame 410 of FIG. 4. At this time, the signal can be processed to represent the outlines according to the length of the objects and to include the depth information in each outline. The depth information can be obtained using a time of flight taken for the infrared light transmitted from the infrared transmitter 310 to arrive at the optical receiver 320. Even an apparatus which locates the user by transmitting and receiving the ultrasonic waves or the radio waves can acquire the depth information using the time of flight of the ultrasonic waves or the waves.

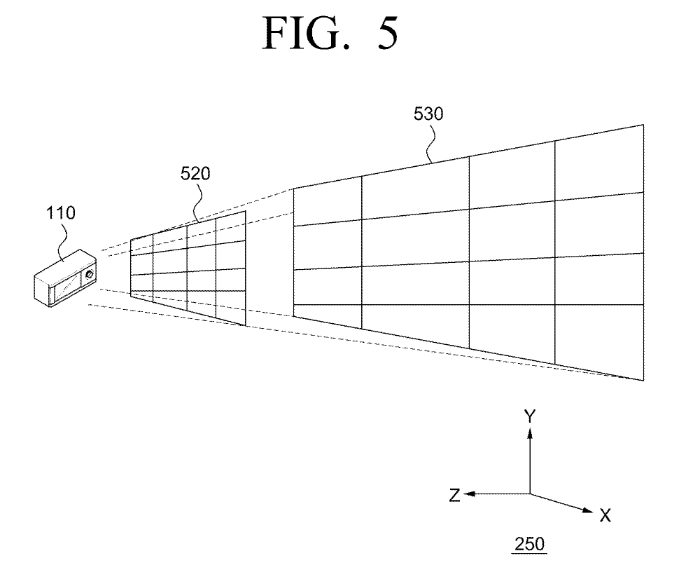

FIG. 5 is a block diagram illustrating the sensor and a shooting location according to an exemplary embodiment.

FIG. 5 depicts a face 520 having a first depth and a face 530 having a second depth, which are photographed by the sensor 110. The photographed faces 520 and 530 can include regions virtually divided in the image frame. The three dimensional axes 250 in FIGS. 2 and 5 indicate the directions for the x, y, and z axes to represent the hand 270 away from the sensor 110; that is, the user's location.

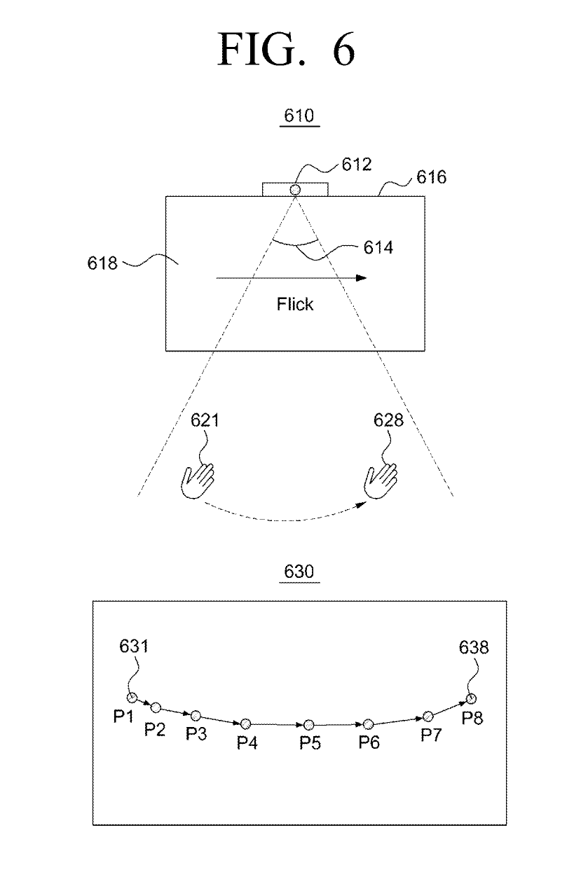

FIG. 6 is a block diagram illustrating the user's motion in the image frame according to an exemplary embodiment.

A device 616 can include a screen 618 and the response providing apparatus 100. The response providing apparatus 100 of the user interface can include a sensor 612. The block diagram 610 shows the user's motion which moves the user (or the user's hand) from a location 621 to a location 628 along the trajectory of the broken line within the field of view 614 of the sensor 612.

The sensor 612 can obtain the image frame by capturing the user. When the user's location in eight image frames obtained from the user's motion moving from the location 621 to the location 628 of the user is represented as points P1 631 through P8 638, the image 630 shows the points P1 631 through P8 638 included in one image frame. At this time, the image frames can be obtained at regular time intervals. For example, the controller 130 can track the user's location or coordinates from the eight image frames obtained over the time period of 82 msec for example. Table 1 can be information relating to the location of the first user corresponding to the points P1 631 through P8 638 obtained from the motion for the predefined gesture (e.g., the flick of a hand) of the first user.

TABLE 1

| | Frame | X | Y | Z |
|---|---|---|---|---|
| P1 | 1 | 10 | 53 | 135 |
| P2 | 2 | 11 | 52 | 134 |
| P3 | 3 | 17 | 51.3 | 132 |
| P4 | 4 | 27 | 51.2 | 131 |
| P5 | 5 | 39 | 51.4 | 130 |
| P6 | 6 | 45 | 52 | 132 |
| P7 | 7 | 51 | 54 | 135 |
| P8 | 8 | 57 | 56 | 137 |

Herein, the unit of the x, y, and z axis coordinates can be, for example, in cm. The unit can be a unit predetermined by the sensor 612 or the controller 130. For example, the unit of the x and y axis coordinates can be a pixel size in the image frame. The coordinate value may be a value obtained in a preset unit in the image frame, or a value processed by considering the measure according to the distance (or the depth) from the object within the field of view 614 of the sensor 612.

In the leading mode, the controller 130 can control the response providing apparatus 100 to provide the user with the guide for the predefined gesture. For example, the controller 130 can control the response providing apparatus to instruct the display to play an image or a demonstration video for the predefined gesture (e.g., the flick of a hand) on the screen 618. In so doing, the sensor 612 can obtain at least one first image frame by capturing the first motion of the first user who imitates the predefined gesture. The controller 130 can acquire the identification information of the first user. When the at least one first image frame includes the information about the location of the first user corresponding to the points P1 631 through P8 638, the controller 130 can obtain the information of the motion in the three dimensional space from the location information of the first user. For example, based on the P1 631 and the P8 638 which are the start and the end of the first motion of the first user of Table 1, the controller 130 can represent, for example, the movement amount of the x axis direction motion, the movement amount of the y axis direction motion, and the movement amount of the z axis direction motion for the flick gesture of Table 2, shown below. That is, when the location of the first user is represented as P (the x coordinate, the y coordinate, and the z coordinate) using Table 1, the controller 130 can calculate the first motion information of the first user including the amount and/or the direction of the motion by subtracting P1 (10, 53, 135) from P8 (57, 56, 137). Also, the controller 130 can calculate the first motion information of the first user including the variation range of the coordinates of the P1 631 and the P8 638. For example, based on Table 1, the variation range from the P1 631 to the P8 638 can be 47 in the x axis, 3 in the y axis, and 2 in the z axis. Using the set of the image frames obtained by capturing the first motion of the first user imitating the predefined gesture over one time, the controller 130 can calculate the training data or the data contained the gesture profile using the information of the motion of the first user over one time. For example, the training data or the data contained in the gesture profile can be calculated by operating based on the average amount of motion and/or the average amount of variation range with respect to the motion information. When calculating the training data or the data contained in the gesture profile, the controller 130 can add or subtract a margin or a certain value to or from the motion information by considering that the corresponding data is the comparison value for determining whether the gesture takes place. The controller 130 can differently apply the calculation of the information of the interval of the used image frames and the motion so as to fully represent the shape of the motion according to the gesture.

The controller 130 can control to retain the calculated training data or gesture profile in the memory 120. Table 2 can be the training data or the gesture profile of the first user retained in the user area of the first user in the memory 120. Herein, the amount unit of the x, y, and z axis direction motion can be, for example, in centimeters. For example, data corresponding to the push gesture in the gesture profile of the first user can be motion information including the direction and the size of −1 cm in the x axis, +2 cm in the y axis, and −11 in the z axis.

TABLE 2

| | | X | Y | Z |
|---|---|---|---|---|
| | Gesture | axis direction | axis direction | axis direction |
| First user | Flick | +47 | +3 | +2 |
| identification | Push | −1 | +2 | −11 |
| information | . | . | . | . |
| | . | . | . | . |
| | . | . | . | . |

The data corresponding to the predefined gesture in the gesture profile of the first user of Table 2 can be maintained to include at least two coordinates in the x, y, and z axes, respectively.

When the gesture profile of the first user shown in Table 2 is retained in the memory 120, the controller 130 can use the gesture profile of the first user to provide the user interface in response to the second motion of the first user. That is, the controller 130 can identify the first user, and can access the gesture profile of the first user retained in the user area of the first user in the memory 120. The controller 130 can determine which one of the one or more gestures relates to the second motion of the first user by comparing the second motion of the first user in the second image frame and at least one data of the stored gesture profile of the first user. For example, the controller 130 can compare the information about the second motion and the data corresponding to the at least one gesture and thus determine the gesture that correlates the closest to the gesture indicated by the corresponding second motion. The controller 130 can compare the information about the second motion of the first user and the positional displacements data corresponding to the at least one gesture, and thus identify the corresponding gesture or determine whether the corresponding gesture occurs. For example, when the second motion is +45, −2, −1 positional displacement in the x, y, and z axis direction, this positional displacement most closely matches/correlates with the flick gesture. As such, the controller 130 can determine that the second motion of the first user relates to the flick gesture. If the flick gesture is set to take place when the positional displacement in the x or y axis direction is greater than a predetermined amount, the amount of motion in the x or y axis direction does not exceed 47 and thus the interface in response to the corresponding gesture can be omitted.

Table 3 can be the training data or the gesture profile of the second user retained in the user area of the second user in the memory 120. Herein, the amount unit of the x, y, and z axis direction motion can be, for example, in centimeters. For example, the data corresponding to the flick gesture and the push gesture in Table 3 and Table 2 can differ from each other.

TABLE 3

| | | X | Y | Z |
|---|---|---|---|---|
| | Gesture | axis direction | axis direction | axis direction |
| Second user | Flick | +35 | −5 | −13 |
| identification | Push | 0 | −2 | −10 |
| information | . | . | . | . |
| | . | . | . | . |
| | . | . | . | . |

As shown above, by adaptively using the training data or the gesture profile of the corresponding user, the response providing apparatus 100 can increase the accuracy of identifying the gesture in the user's motion. For example, the correlation between the motion of the second user for the flick gesture and the data corresponding to the flick gesture in the gesture profile of the second user can be greater than the correlation between the motion of the second user and the data corresponding to the flick gesture in the basic gesture profile. Orthogonality between the flick gesture of the gesture profile of the second user and the other gestures can be high.

Table 4 can be the basic gesture profile for an unspecified user retained in the memory 120. Herein, the unit of motion in the x, y, and z axis direction can be, for example, in centimeters. When the user cannot be identified, the controller 130 can provide the user interface in response to the second motion using the second motion of the user in the second image frame and the basic gesture profile. When there is no gesture profile or the training data obtained in the leading mode, the controller 130 can use the basic gesture profile as initial data that will indicate the motion information of the identified user.

TABLE 4

| | | | |
|---|---|---|---|
| Gesture | X axis direction | Y axis direction | Z axis direction |

| | | | |
|---|---|---|---|
| Flick | +40 | 0 | 0 |
| Push | 0 | 0 | −12 |
| . | . | . | . |
| . | . | . | . |
| . | . | . | . |

In the following mode, the controller 130 can obtain the updated gesture profile of the user by modifying the first data corresponding to the first gesture of the gesture profile of the user to the second data based on Equation 1 using user's second motion.

xₙ=α·x₀+β·x₁+Cₓ

yₙ=α·y₀+β·y₁+C_{y}

zₙ=α·z₀+β·z₁+C_{z}

α=β=1 [Equation 1]

Herein, xₙ denotes the motion amount in the x axis direction in the second data, yₙ denotes the motion amount in the y axis direction in the second data, zₙ denotes the motion amount in the z axis direction in the second data, x₀ denotes the motion amount in the x axis direction in the first data, y₀ denotes the motion amount in the y axis direction in the first data, z₀ denotes the motion amount in the z axis direction in the first data, x₁ denotes the user's motion amount in the x axis direction, y₁ denotes the user's motion amount in the y axis direction, z₁ denotes the user's motion amount in the z axis direction, α and β denote real numbers greater than zero, and Cₓ, C_{y} and C_{z} denote real constants.

For example, the memory 120 can store the information of the preset number of the user's motions corresponding to the first gesture obtained before the user's second motion in the leading mode or in the following mode. The controller 130 can calculate an average motion amount from the information of the preset number of the user motions and thus check whether a difference between the user's second motion amount and the average motion amount is greater than a preset value. Herein, the difference between the user's second motion amount and the average motion amount can indicate the difference in the motion amount in the x, y, and z axis directions respectively. When checking whether the difference is greater than the preset value, the controller 130 may use the first data corresponding to the first gesture of the user's gesture profile, in place of the average motion amount. When the difference is not greater than (smaller than or equal to) the preset value according to the checking result, the controller 130 can obtain the updated gesture profile of the user from the user's second motion based on Equation 1. When the difference is greater than the preset value, the controller 130 can omit the calculation of Equation 1 or omit the updating of the gesture profile by setting β of Equation 1 to zero. When the difference is greater than the preset value, the controller 130 may alter α and β of Equation 1 differently from α and β when the difference is not greater than the preset value, and may update the gesture profile based on Equation 1 with the altered α and β. For example, β when the difference is greater than the preset value can be smaller than β when the difference is not greater than the preset value.

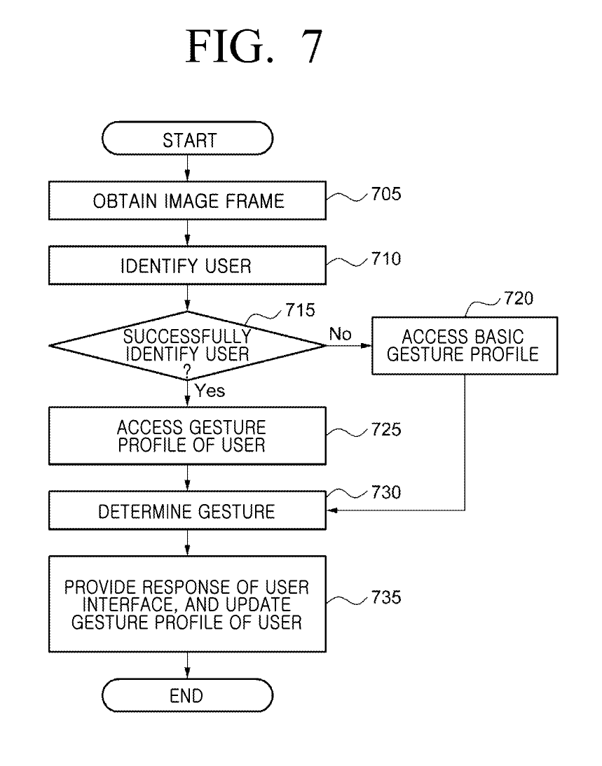

Hereafter, a method illustrating providing the response of the user interface is explained by referring to FIGS. 7 through 10. Operations are explained with the exemplary response providing apparatus 100 illustrated in FIG. 1 or its components.

FIG. 7 is a flowchart illustrating a method of providing the response of the user interface according to an exemplary embodiment.

In operation 705, the sensor 110 of the response providing apparatus 100 can obtain the image frame by capturing the user.

In operation 710, the controller 130 can identify the user. The memory 120 can further retain the user's identification information together with the user's gesture profile in the user area. The controller 130 can identify the user by determining whether the user's shape matches the user's identification information.

In operation 715, the controller 130 can determine whether the user identification is successful. When the user cannot be identified, the controller 130 can still provide the user interface in response to the user's motion using the user's motion in the image frame and the basic gesture profile for an unspecified user in operation 720. That is, if the user is not identified in operation 715, the basic gesture profile is obtained in operation 720.

When successfully identifying the user, the controller 130 can access the user's gesture profile retained in the user area of the memory 120 in operation 725. The gesture profile includes at least one data corresponding to at least one gesture, and the at least one data indicating the motion information in the three dimensional space. Herein, the motion information in the three dimensional space can include the information regarding motion amount in the x axis direction in the image frame, motion amount in the y axis direction in the image frame, and motion amount in the z axis direction perpendicular to the image frame. The motion information in the three dimensional space can include at least two three-dimensional coordinates including the x axis component, the y axis component, and the z axis component.

At least one gesture can include at least one of the flick, the push, the hold, the circling, the gathering, and the widening. The response of the user interface can include at least one of the display power-on, the display power-off, the menu display, the cursor movement, the change of the activated item, the item selection, the operation corresponding to the item, the change of the display channel, and the volume change.

The user's gesture profile can be updated with the data calculated from the user's first motion in the first image frame. The first image frame is produced by capturing the user's first motion imitating the predefined gesture.

In operations 730 and 735, the controller 130 can provide the user interface in response to the user's motion by comparing the user's motion in the image frame and the at least one data in the user's gesture profile. That is, in operation 730, the controller 130 can compare the user's motion in the image frame and the at least one data in the user's gesture profile and thus determine to which one of the at least one gesture the user's motion relates to. In operation 735, the controller 135 can provide the response of the user interface corresponding to the gesture according to the determination result in operation 730.

In operation 735, the controller 130 can further update the user's gesture profile using the user's motion. For example, the controller 130 can obtain the user's updated gesture profile by altering the first data corresponding to the first gesture of the user's gesture profile to the second data based on Equation 2 with the user's motion.

xₙ=α·x₀+β·x₁+Cₓ

yₙ=α·y₀+β·y₁+C_{y}

zₙ=α·z₀+β·z₁+C_{z}

α+β=1 [Equation 2]

Herein, xₙ denotes the amount of motion in the x axis direction in the second data, yₙ denotes the amount of motion in the y axis direction in the second data, zₙ denotes the amount of motion in the z axis direction in the second data, x₀ denotes the amount of motion in the x axis direction in the first data, y₀ denotes the amount of motion in the y axis direction in the first data, z₀ denotes the amount of motion in the z axis direction in the first data, x₁ denotes the amount of motion in the x axis direction of the user's motion, y₁ denotes the amount of motion in the y axis direction of the user's motion, z₁ denotes the amount of motion in the z axis direction of the user's motion, α and β denote real numbers greater than zero, and Cₓ, C_{y} and C_{z} denote real constants.

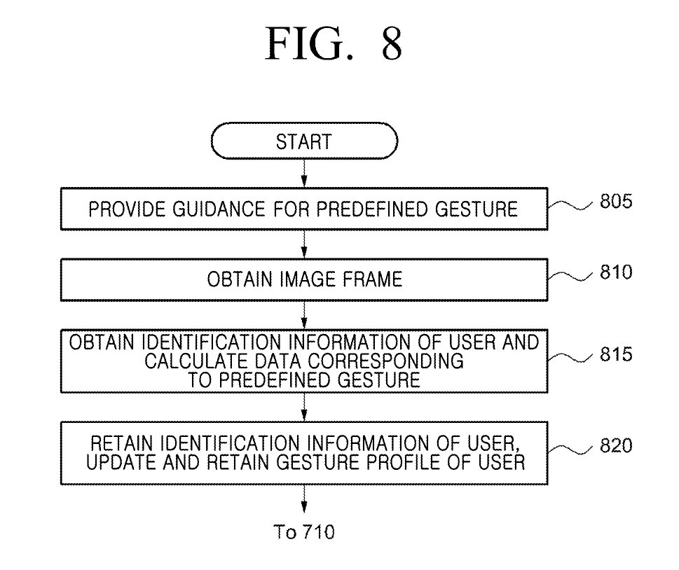

FIG. 8 is a flowchart illustrating a method for providing the response of the user interface according to an exemplary embodiment.

In operation 805, the controller 130 of the response providing apparatus 100 can control the response providing apparatus to provide guidance for the predefined gesture.

In operation 810, the sensor 110 can obtain the first image frame by capturing the user's first motion where the user imitates the predefined gesture.

In operation 815, the controller 130 can obtain the user's identification information. In operation 815, the controller 130 can calculate the data indicating the motion information in the three dimensional space corresponding to the predefined gesture from the user's first motion in the first image frame.

In operation 820, the memory 120 can further retain the user's identification information together with the user's gesture profile in the user area. Also, the memory 120 can update the user's gesture profile with the data calculated in operation 815 and retain it in the user area of the memory 120. The gesture profile includes at least one data corresponding to at least one gesture.

After operation 820, the response providing apparatus 100 can finish its operation or go to operation 710 illustrated with reference to FIG. 7. Exemplary operations 710 through 735 have been described and some of operations 710 through 735 are briefly additionally explained below with reference to a second movement by the user.

In operation 710, the controller 130 can identify the user.

In operation 725, the controller 130 can access the user's gesture profile retained in the user area of the memory 120.

In operation 730, the controller 130 can compare the user's second motion of the second image frame and the at least one data of the user's gesture profile and thus determine which one of the at least one gesture the user's second motion relates to.

In operation 735, the controller 130 can provide the response of the user interface corresponding to the gesture according to the determination result in operation 730.

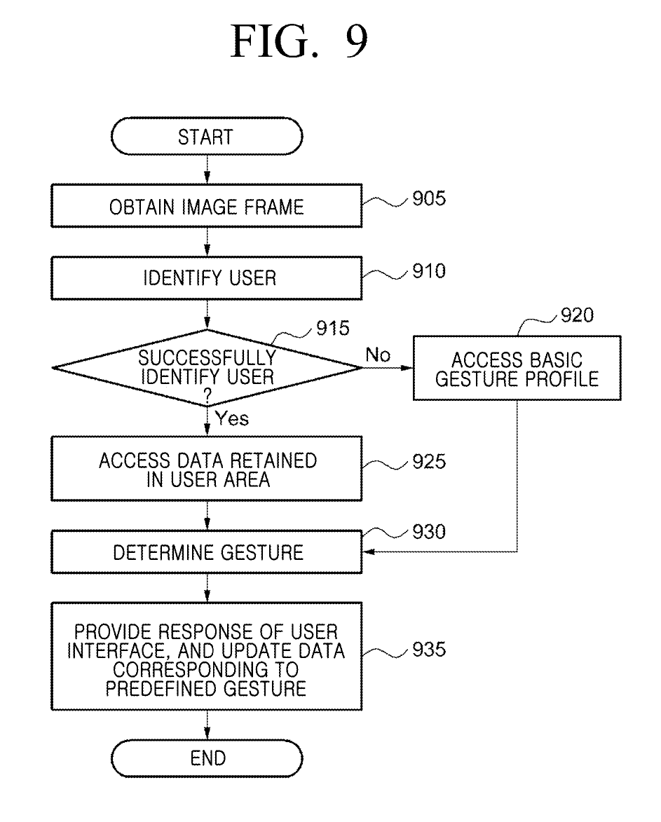

FIG. 9 is a flowchart illustrating a method of providing the response of the user interface according to another exemplary embodiment.

In operation 905, the sensor 110 of the response providing apparatus 100 can obtain the image frame by capturing the user.

In operation 910, the controller 130 can identify the user. The memory 120 can further retain the user's identification information together with the user's training data in the user area. The controller 130 can identify the user by determining whether the user's shape matches the user's identification information.

In operation 915, the controller 130 can determine whether the user identification is successful. When the user cannot be identified, the controller 130 can provide the user interface in response to the user's motion using the user's motion in the image frame and the basic gesture profile for an unspecified user in operation 920. That is, if the user is not identified in operation 915, the basic gesture profile is obtained in operation 920.

When successfully identifying the user, the controller 130 can access the training data indicating the user's motion information in the three dimensional space corresponding to the predefined gesture retained in the user area of the memory 120 in operation 925. Herein, the motion information in the three dimensional space can include the information of the motion amount in the x axis direction in the image frame, the motion amount in the y axis direction in the image frame, and the motion amount in the z axis direction perpendicular to the image frame. The motion information in the three dimensional space can include at least two three-dimensional coordinates including the x axis component, the y axis component, and the z axis component.

The at least one gesture can include at least one of the flick, the push, the hold, the circling, the gathering, and the widening. The response of the user interface can include at least one of the display power-on, the display power-off, the menu display, the cursor movement, the change of the activated item, the item selection, the operation corresponding to the item, the change of the display channel, and the volume change.

The training data can be calculated from the user's first motion in the first image frame which is obtained by capturing the user's first motion imitating the predefined gesture.

In operations 930 and 935, the controller 130 can provide the user interface in response to the user's motion by comparing the user's motion in the image frame and the training data retained in the user area. That is, in operation 930, the controller 130 can compare the user's motion in the image frame and the training data retained in the user area and thus determine which predefined gesture matches the user's motion. In operation 935, the controller 130 can provide the response of the user interface corresponding to the predefined gesture.

In operation 935, the controller 130 can update the training data corresponding to the predefined gesture using the user's motion. For example, the controller 130 can update the training data to new data based on Equation 3 with the user's motion.

xₙ=α·x₀+β·x₁+Cₓ

yₙ=α·y₀+β·y₁+C_{y}

zₙ=α·z₀+β·z₁+C_{z}

α+β=1 [Equation 3]

Herein, xₙ denotes the motion amount in the x axis direction in the new data, yₙ denotes the motion amount in the y axis direction in the new data, zₙ denotes the motion amount in the z axis direction in the new data, x₀ denotes the motion amount in the x axis direction in the training data, y₀ denotes the motion amount in the y axis direction in the training data, z₀ denotes the motion amount in the z axis direction in the training data, x₁ denotes the motion amount in the x axis direction of the user's motion, y₁ denotes the motion amount in the y axis direction of the user's motion, z₁ denotes the motion amount in the z axis direction of the user's motion, α and β denote real numbers greater than zero, and Cₓ, C_{y} and C_{z} denote real constants.

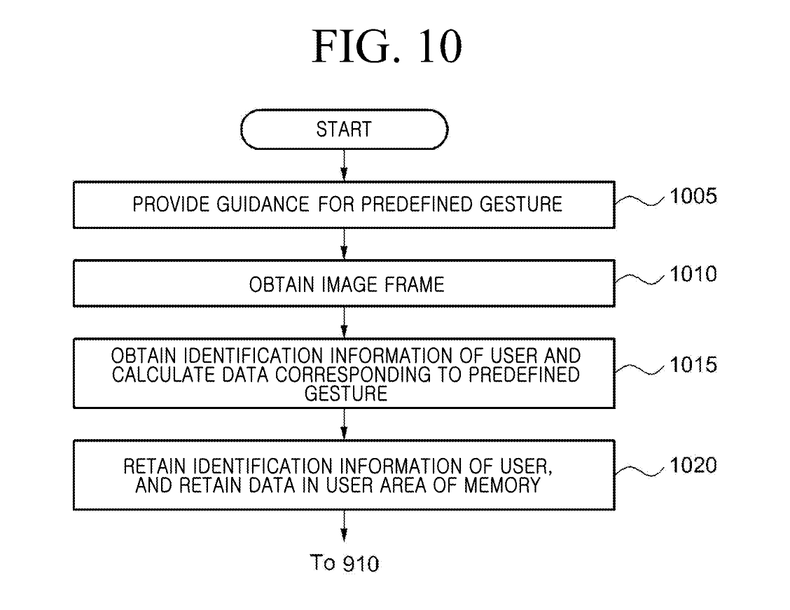

FIG. 10 is a flowchart illustrating a method of providing the response of the user interface according to another exemplary embodiment.

In operation 1005, the controller 130 of the response providing apparatus 100 can control the response providing apparatus 100 to provide guidance for the predefined gesture.

In operation 1010, the sensor 110 can obtain the first image frame by capturing the first motion of the user who imitates the predefined gesture.

In operation 1015, the controller 130 can obtain the user's identification information. In operation 1015, the controller 130 can calculate the training data indicating the motion information in the three dimensional space corresponding to the predefined gesture from the user's first motion in the first image frame.

In operation 1020, the memory 120 can further retain the user's identification information together with the user's training data in the user area. Also, the memory 120 can retain the training data calculated in operation 1015 in the user area of the memory 120.

After operation 1020, the response providing apparatus 100 can finish its operation or go to operation 910 illustrated in FIG. 9. Since operations 910 through 935 have been described, some of operation 910 through 935 will be additionally explained below with reference to a second movement by the user.

In operation 910, the controller 130 can identify the user.

In operation 925, the controller 130 can access the training data retained in the user area of the user in the memory 120.

In operation 930, the controller 130 can compare the user's second motion of the second image frame and the training data retained in the user area of the user and thus determine whether the user's second motion is the predefined gesture.

In operation 935, the controller 130 can provide the response of the user interface corresponding to the predefined gesture.

The above-stated exemplary embodiments can be realized as program commands executable by various computer means and recorded to a computer-readable medium. The computer-readable medium can include a program command, a data file, and a data structure alone or in combination. The program command recorded to the medium may be designed and constructed especially for the present general inventive concept, or well-known to those skilled in the computer software. The computer-readable medium may include tangible, non-transitory medium such as magnetic recording medium, such as a hard disc, or a nonvolatile memory, such as an EEPROM or a flash memory, but is not limited thereto. As an alternative, the medium may be carrier waves.

The foregoing exemplary embodiments are merely exemplary and are not to be construed as limiting the present general inventive concept. The present teaching can be readily applied to other types of apparatuses. Also, the description of the exemplary embodiments of the present general inventive concept is intended to be illustrative, and not to limit the scope of the claims, and many alternatives, modifications, and variations will be apparent to those skilled in the art.

What is claimed is:

1. A method of providing a user interface in response to a user motion, the method comprising:
capturing the user motion in an image frame;
identifying a user of the user motion;
accessing a gesture profile of the user, the gesture profile comprising data that identifies at least one gesture and data that identifies the user motion corresponding to a respective gesture;
comparing the user motion in the image frame and the at least one data in the gesture profile of the user to determine the respective gesture; and
providing the user interface in response to the user motion based on the comparison.

2. The method of claim 1, further comprising:
updating the gesture profile of the user using the user motion.

3. The method of claim 1, further comprising storing in an area of a memory allocated to the user identification information together with the gesture profile of the user,
wherein the identifying the user comprises determining whether a shape of the user matches the user identification information.

4. The method of claim 1, further comprising:
if the user is not identified, providing the user interface in response to the user motion using the user motion in the image frame and a basic gesture profile for an unspecified user.

5. The method of claim 1, wherein the at least one data in the gesture profile indicates information relating to the user motion in a three dimensional space.

6. The method of claim 5, wherein the information relating to the motion in the three dimensional space comprises information relating to an amount of motion in an x axis direction in the image frame, an amount of motion in a y axis direction in the image frame, and an amount of motion in a z axis direction perpendicular to the image frame.

7. The method of claim 6, further comprising:
obtaining an updated gesture profile of the user by modifying first data corresponding to a first gesture in the gesture profile of the user, to second data based on the following equation with the motion of the user:
xₙ=α·x₀+β·x₁+Cₓ
yₙ=α·y₀+β·y₁+C_{y}
zₙ=α·z₀+β·z₁+C_{z}
α+β=1
where xₙ denotes the amount of motion in the x axis direction in the second data, yₙ denotes the amount of motion in the y axis direction in the second data, zₙ denotes the amount of motion in the z axis direction in the second data, x₀ denotes the amount of motion in the x axis direction in the first data, y₀ denotes the amount of motion in the y axis direction in the first data, z₀ denotes the amount of motion in the z axis direction in the first data, x₁ denotes the amount of motion in the x axis direction of the user motion, y₁ denotes the amount of motion in the y axis direction of the user motion, z₁ denotes the amount of motion in the z axis direction of the user motion, α and β denote real numbers greater than zero, and Cₓ, C_{y} and C_{z} denote real constants.

8. The method of claim 5, wherein the information relating to the motion in the three dimensional space comprises at least two three-dimensional coordinates comprising an x axis component, a y axis component, and a z axis component.

9. The method of claim 1, wherein the gesture profile of the user is updated with the data calculated from a first user motion in a first image frame, and wherein the first image frame is obtained by capturing the first user motion which imitates a predefined gesture.

10. The method of claim 1, wherein the at least one gesture comprises at least one of flick, push, hold, circling, gathering, and widening.

11. The method of claim 1, wherein the user interface provided in the response comprises at least one of a display power-on, a display power-off, display a menu, a movement of a cursor, a change of an activated item, a selection of an item, an operation corresponding to the item, a change of a display channel, and a volume change.

12. An apparatus for providing a user interface in response to a user motion, the apparatus comprising:
a sensor which captures the user motion in an image frame;
a memory which retains a gesture profile of a user, the gesture profile comprising at least one data that identifies at least one gesture and at least one data that identifies the user motion corresponding to a respective gesture; and
a controller which identifies the user of the user motion, which accesses the gesture profile of the user, and which compares the user motion in the image frame with the at least one data in the gesture profile of the user to determine the respective gesture, and which provides the user interface in response to the user motion based on the comparison.

13. The apparatus of claim 12, wherein the controller updates the gesture profile of the user using the user motion.

14. The apparatus of claim 12, wherein the at least one data in the gesture profile indicates information relating to the user motion in a three dimensional space and wherein the information relating to the user motion in the three dimensional space comprises information relating to an amount of motion in an x axis direction in the image frame, an amount of motion in a y axis direction in the image frame, and an amount of motion in a z axis direction perpendicular to the image frame.

15. The apparatus of claim 12, wherein the at least one data in the gesture profile indicates information relating to the user motion in a three dimensional space and wherein the information relating to the motion in the three dimensional space comprises at least two three-dimensional coordinates comprising an x axis component, a y axis component, and a z axis component.

16. The apparatus of claim 12, wherein the gesture profile of the user is updated with the data calculated from a first user motion in a first image frame, and wherein the first image frame is obtained by capturing a first user motion which imitates a predefined gesture.

17. A method of providing a user interface in response to a user motion, the method comprising:
capturing a first user motion which imitates a predefined gesture in a first image frame;
calculating data indicating a three dimensional motion information which corresponds to the predefined gesture, from the first user motion provided in the first image frame;
updating a user gesture profile with the calculated data;
storing the updated gesture profile in an area in a memory allocated to a user that performs the user motion, wherein the user gesture profile comprises at least one data corresponding to at least one gesture;
identifying the user of the user motion;
accessing the user gesture profile; and
comparing a second user motion in a second image frame and the at least one data in the user gesture profile and providing the user interface in response to the user second motion.

18. The method of claim 17, wherein the capturing the first user motion comprises:
providing guidance to the user to perform the predefined gesture; and
obtaining user identification information.

19. The method of claim 17, further comprising:
updating the user gesture profile using the second user motion.

20. An apparatus for providing a user interface in response to a user motion, the apparatus comprising:
a sensor which captures a first motion of the user which imitates a predefined gesture in a first image frame;
a controller which calculates data indicating a three dimensional motion information which corresponds to the predefined gesture, from the first user motion provided in the first image frame; and
a memory which stores an updated user gesture profile in an area of a memory allocated to a user that performs the user motion, wherein the updated user gesture profile is updated with the calculated data and comprises at least one data corresponding to at least one gesture,
wherein the controller identifies the user of the user motion, accesses the user gesture profile, and compares a second user motion in a second image frame and the at least one data in the user gesture profile, and provides the user interface in response to the second user motion.
